(19) United States
(12) Patent Application Publication
(10) Pub. No.: US 2009/0318133 A1
(43) Pub. Date: Dec. 24, 2009

(54) ERROR DETECTOR, ERROR DETECTING METHOD AND CONTROL PROGRAM THEREOF

(76) Inventor: TOMOHIRO AZUMA, Tokyo (JP)

Correspondence Address: Mr. Jackson Chen, 6535 N. STATE HWY 161, IRVING, TX, 75039, US

(21) Appl. No.: 12/488,904

(22) Filed: Jun. 22, 2009

(30) Foreign Application Priority Data
Jun. 20, 2008 (JP) 161686/2008

(51) Int. Cl. H04W 24/00; H04B 17/00

(52) U.S. Cl. 455/423; 455/226.1

(57) ABSTRACT

An error detector includes: an automatic gain control amplifier for amplifying or attenuating an input signal with a variable gain and outputting an output signal; and a control unit for controlling the variable gain so as to keep a signal level of the output signal constant, obtaining an overall gain according to the variable gain and the signal level of the input signal, and detecting an error according to a result of a comparison of the overall gain with a first threshold value.

### INCORPORATION BY REFERENCE

This application is based upon and claims the benefit of priority from Japanese Patent Application No. 2008-161686, filed on Jun. 20, 2008, the disclosure of which is incorporated herein in its entirety by reference.

### TECHNICAL FIELD

The present invention relates to an error detector, an error detecting method and an error detection program, and in particular, relates to an error detector, an error detecting method and an error detection program which have a minimal impact on an input signal.

### BACKGROUND ART

In some mobile communication systems including mobile communication wireless networks, a plurality of mobile terminals are connected with each other by using a multiple access scheme. When such systems are used, the systems are required to stably operate. It is requested that errors do not occur, which cause the systems to stop the operation. When the errors will occur, the errors have to be detected quickly and the systems have to be restored. Accordingly, it is extremely important to detect errors of wireless base stations.

A wireless base station includes a transmitter and a receiver. The error of the transmitter can be easily detected by monitoring a signal level of a downlink communication signal generated by the transmitter. Meanwhile, because a reception signal inputted to the receiver from an antenna includes an uplink communication signal and an interference wave, the electric power of the reception signal varies at every moment. Therefore, the reception signal can not be used as a test signal for error detection of the receiver. Accordingly, a predetermined test signal is inputted to the receiver instead of the reception signal, a receiving condition of the receiver is monitored, and the error of the receiver is detected.

A method is disclosed for detecting an error of a reception unit by using a signal generated by a transmission unit in for example, Japanese Patent Application Laid-Open No. 2002-246978. In this method, a transmission monitor signal which is a part of a transmission signal generated by the transmission unit is converted into a reception baseband signal in the reception unit. The error of the reception unit is detected by monitoring the reception baseband signal by a baseband unit.

Incidentally, the method using the test signal may increase a size of a device and a power consumption of the device. Therefore, a method has been proposed for detecting an error of a receiver without using the special test signal. A method is disclosed in which occurrence of an error of a receiver is detected by monitoring a gain of two systems of signal paths in the receiver in for example, Japanese Patent Application Laid-Open No. 2006-319616. In this method, a first path in which a signal passes through a Low Noise Amplifier (LNA) and a second path in which the signal does not pass through the LNA are provided in the receiver. Normality of the receiver is checked by switching between the first path and the second path and monitoring the gain of the each path.

### SUMMARY

An exemplary object of the present invention is to provide an error detector, an error detecting method and an error detection program which have simple configuration and can detect an error without affecting system operation and with minimal impact on an input signal.

An error detector according to a first exemplary aspect of the invention includes: an automatic gain control amplifier for amplifying or attenuating an input signal with a variable gain and outputting an output signal; and a control unit for controlling the variable gain so as to keep a signal level of the output signal constant, obtaining an overall gain according to the variable gain and the signal level of the input signal, and detecting an error according to a result of a comparison of the overall gain with a first threshold value.

An error detector according to a second exemplary aspect of the invention includes: variable gain amplifying means for amplifying or attenuating an input signal with a variable gain and outputting an output signal; and controlling means for controlling the variable gain so as to keep a signal level of the output signal constant, obtaining an overall gain according to the variable gain and a signal level of the input signal, and detecting an error according to a result of a comparison of the overall gain with a first threshold value.

An error detecting method according to a third exemplary aspect of the invention includes: controlling a variable gain set to an automatic gain control amplifier which amplifies or attenuates an input signal with the variable gain and outputs an output signal, so as to keep a signal level of the output signal constant; obtaining an overall gain according to the variable gain and a signal level of the input signal; and detecting an error according to a result of a comparison of the overall gain with a first threshold value.

A control program for an error detector according to a fourth exemplary aspect of the invention includes the operations of: controlling a variable gain set to an automatic gain control amplifier provided in the error detector which amplifies or attenuates an input signal with the variable gain and outputs an output signal so as to keep a signal level of the output signal constant; obtaining an overall gain according to the variable gain and a signal level of the input signal; and detecting an error according to a result of a comparison of the overall gain with a first threshold value.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of an error detector of a first exemplary embodiment of the present invention;

FIG. 2 is a flowchart showing an operation of a control unit of an error detector of a first exemplary embodiment of the present invention;

FIG. 3 is a block diagram showing a configuration of an error detector of a second exemplary embodiment of the present invention;

FIG. 4 is a block diagram showing a configuration of a wireless base station of a third exemplary embodiment of the present invention;

FIG. 5 shows an example of a time chart of a gain adjustment operation of an automatic gain control amplifier in a wireless base station of a third exemplary embodiment of the present invention;

FIG. 6 shows an example of a flowchart of an error detection operation of a control unit in a wireless base station of a third exemplary embodiment of the present invention;

FIG. 7 shows another example of a flowchart of an error detection operation of a control unit in a wireless base station of a third exemplary embodiment of the present invention; and

FIG. 8 is a block diagram showing a configuration of a wireless base station of a fourth exemplary embodiment of the present invention.

### EXEMPLARY EMBODIMENT

Exemplary embodiments of the present invention will now be described in detail in accordance with the accompanying drawings.

### 1. First Exemplary Embodiment

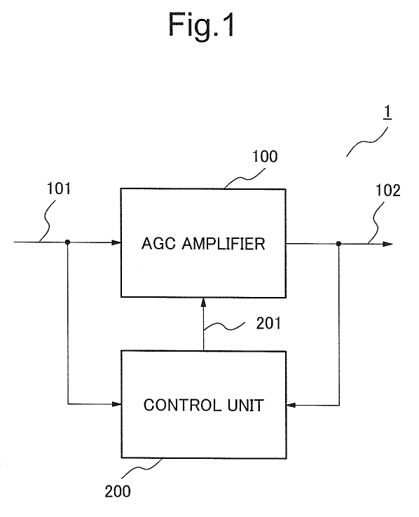

An error detector of a first exemplary embodiment of the present invention will be described. FIG. 1 is a block diagram showing a configuration of the error detector of the first exemplary embodiment of the present invention. An error detector 1 of the exemplary embodiment includes an automatic gain control (AGC) amplifier 100 and a control unit 200.

The AGC amplifier 100 that is an amplifier whose gain can be changed amplifies or attenuates an input signal 101 at a set gain and outputs an output signal 102.

The control unit 200 outputs a gain control signal 201 for keeping a signal level of an output of the error detector 1, which is a signal level of an output signal 102, constant and sets the gain of the AGC amplifier 100 (hereinafter, referred to as “AGC amplifier gain”). Namely, the control unit 200 performs AGC of the AGC amplifier 100.

The control unit 200 calculates “overall gain” of the error detector 1 according to the AGC amplifier gain set to the AGC amplifier 100 and the signal level of the input signal 101. The “overall gain” is a ratio of the signal level of the output signal 102 to the signal level of the input signal 101 of the error detector 1 and a gain of the whole error detector 1.

The control unit 200 compares the calculated overall gain with a predetermined threshold value (hereinafter, referred to as “first threshold value”) and detects whether or not an error of a signal source of the input signal 101 occurs. For example, the control unit 200 judges that the error occurs when the overall gain exceeds the first threshold value, and judges that the error does not occur when the overall gain is equal to or smaller than the threshold value. When the control unit 200 judges that the error occurs, it may output an error detection signal to outside. Incidentally, in the present specification, “threshold value” is used for a judgment and is a kind of “criterion value” defining a boundary or a range.

The above judgment may be based whether the overall gain is within a predetermined range or not. The predetermined range is defined by at least one first threshold value. In this case, when the overall gain is not within the predetermined range, the control unit 200 judges that the error occurs, and when the overall gain is within the predetermined range, the control unit 200 judges that error does not occur.

The first threshold value may be changed according to the signal level of the input signal 101. Namely, the overall gain may be compared with the threshold value based on the signal level of the input signal 101 or it may be judged whether or not the overall gain is within the threshold value based on the signal level of the input signal 101.

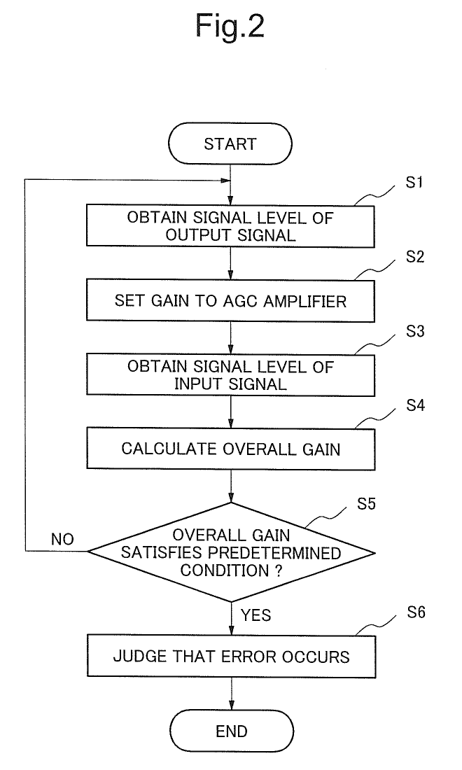

The operation of the error detector 1 of the first exemplary embodiment will be described. FIG. 2 is a flowchart showing an operation of the control unit 200 of the error detector 1 of the exemplary embodiment.

First, the control unit 200 obtains the signal level of the output signal 102 (Step S1). The control unit 200 adjusts the AGC amplifier gain so that the signal level of the output signal 102 is equal to a predetermined level (Step S2). Next, the control unit 200 obtains the signal level of the input signal 101 (Step S3). The overall gain of the error detector is calculated by using the AGC amplifier gain and the signal level of the input signal 101 (Step S4).

The control unit 200 judges whether or not the calculated overall gain satisfies a predetermined condition (Step S5). When the overall gain satisfies the condition, the control unit 200 judges that the error occurs (Step S6). When the overall gain does not satisfy the condition, the control unit 200 judges that the error does not occur and a process returns to Step S1.

A concrete example will be shown with respect to steps S5 and S6. For example, in step S5, the overall gain is compared with the first threshold value and it is judged whether or not the overall gain exceeds the first threshold value. When the overall gain exceeds the first threshold value, it is judged that the error occur in step S6.

After this, the control unit 200 repeats the processes from step S1 to step S5 until the overall gain exceeds the first threshold value, and when the overall gain exceeds the first threshold value, the control unit 200 performs the process in step S6 and ends the process.

As mentioned above, the error detector of the first exemplary embodiment compares the calculated overall gain with the predetermined threshold value and detects the error. Thus, the error detector of the first exemplary embodiment has an advantage in which an error can be detected by using a simple configuration.

A process required for obtaining the overall gain is only a process for obtaining the AGC amplifier gain for keeping the signal level of the input signal and the signal level of the output signal constant. In order to achieve this process, it is enough to split the input signal and the output signal into two, that are a main signal and a branch signal, and the split signals from the input signal and the output signal are inputted into the control unit. Accordingly, the error detector has an advantage in which the error can be detected without affecting system operation and with minimal degradation of reception performance.

### 2. Second Exemplary Embodiment

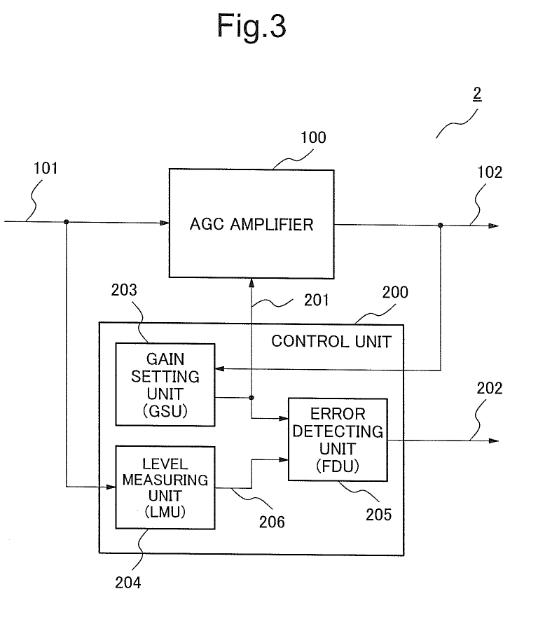

Next, a concrete example of an inner configuration of the control unit 100 of an error detector 1 of the first exemplary embodiment will be described as a second exemplary embodiment. FIG. 3 is a block diagram showing a configuration of the error detector of the second exemplary embodiment. The control unit 200 of the error detector 2 of the exemplary embodiment includes a gain setting unit (GSU) 203, a level measuring unit (LMU) 204 and an error detecting unit (FDU) 205.

The GSU 203 receives the output signal 102 and outputs a gain control signal 201 for keeping the signal level of the output signal 102 constant. The LMU 204 receives the input signal 101, measures the signal level and outputs an input level signal 206. The FDU 205 receives the gain control signal 201 and the input level signal 206 and calculates the overall gain. The FDU 205 judges the condition mentioned in the explanation of the first exemplary embodiment (judgment of the condition in step S5) and outputs an error detection signal 202 when the error is detected.

As mentioned above, the error detector of the second exemplary embodiment also compares the calculated overall gain with the predetermined threshold value and detects the error like the error detector of the first exemplary embodiment. A process required for obtaining the overall gain is only a process for obtaining the AGC amplifier gain for keeping the signal level of the input signal and the signal level of the output signal constant.

Accordingly, the error detector of the second exemplary embodiment also has the same advantage as that of the error detector of the first exemplary embodiment.

### 3. Third Exemplary Embodiment

Next, a concrete example of a wireless base station having the error detector of the present invention is indicated as a third exemplary embodiment. The wireless base station of the exemplary embodiment includes a receiver which receives a signal from a mobile terminal via an antenna. This receiver includes the error detector. Namely, a receiver 40 includes an AGC amplifier 46 which amplifies or attenuates a reception signal from the antenna and outputs the signal and a control unit 49 which sets a gain (AGC amplifier gain) of the AGC amplifier 46 so as to keep an output signal level of the receiver 40 constant. The control unit 49 calculates the overall gain of the receiver 40 according to the AGC amplifier gain, and compares the calculated overall gain with the threshold value of the overall gain for judging that the error does not occur and detects the error of the receiver. This threshold value corresponds to the first threshold value mentioned above.

An error detecting method of the receiver of the third exemplary embodiment includes a step in which the overall gain of the receiver is calculated according to the AGC amplifier gain that is controlled so as to keep the output signal level of the receiver constant and a step in which the calculated overall gain is compared with the first threshold value and the error of the receiver is detected.

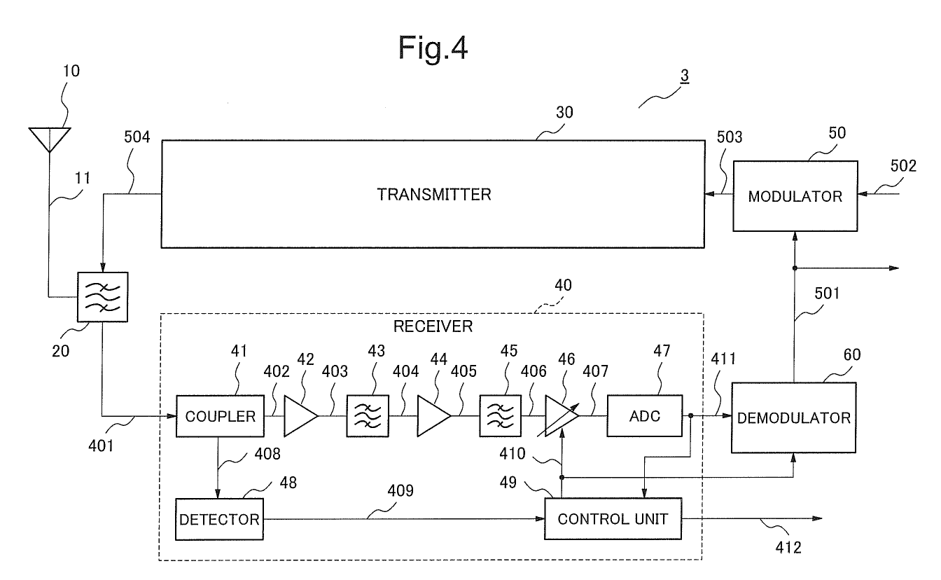

The wireless base station of the third exemplary embodiment will be described by using a drawing. FIG. 4 is a block diagram showing a configuration of the wireless base station of the exemplary embodiment.

A wireless base station 3 performs wireless communication with a mobile terminal (not shown). The wireless base station 3 connects a plurality of mobile terminals to a network (not shown) by using a multiple access scheme. The wireless base station 3 includes an antenna 10, a duplexer (DUP) 20, a transmitter 30, a receiver 40, a modulator 50 and a demodulator 60.

The receiver 40 receives a signal from the mobile terminal via the antenna 10 and the DUP 20. The receiver 40 includes the AGC amplifier 46 and the control unit 49. The AGC amplifier 46 receives a reception signal 401 from the antenna 10 via circuit elements mentioned later, amplifies or attenuates the reception signal 401 and outputs an output signal 407. The control unit 49 controls the AGC amplifier gain so as to keep a signal level of the output signal 407 constant. The control unit 49 calculates the overall gain of the receiver 40 according to the AGC amplifier gain. The calculated overall gain is compared with the first threshold value and the error of the receiver 40 is detected.

The antenna 10 is shared for transmission and reception of a communication signal and has a gain at the desired transmission and reception frequencies. When the antenna 10 receives a wireless signal, it receives not only an uplink wireless communication signal but also an interference wave and outputs a reception signal 11 including the received uplink communication signal and the interference wave to the DUP 20.

The DUP 20 is a device for electrically separating a transmission path and a reception path from each other. The DUP 20 filters the reception signal from the antenna 10 and outputs the filtered signal to a coupler 41 of the receiver 40. “To filter” means “to limit a band of the signal and attenuate an undesired radio wave outside the communication band”.

The transmitter 30 adjusts the signal level (transmission power) of a transmission signal (downlink communication signal) 503 from the modulator 50 and outputs a transmission signal 504 to the DUP 20.

The receiver 40 performs the processes such as filtering, amplification, and the like to the reception signal 401 from the DUP 20 and outputs an output signal 411 to the demodulator 60. The receiver 40 includes the coupler 41, an LNA 42, a first filter 43, an amplifier 44, a second filter 45, the AGC amplifier 46 and an Analog to Digital Converter (ADC) 47, a detector 48 and the control unit 49. The AGC amplifier 46 receives a reception signal 401 from the antenna 10 via the following circuit elements: the coupler 41, the LNA 42, the first filter 43, the amplifier 44 and the second filter 45.

The control unit 49 controls the AGC amplifier gain so as to keep the signal level of the output of the AGC amplifier 46 constant. Namely, the control unit 49 performs an AGC so as to keep the signal level of the output signal 407 constant. The control unit 49 also detects the error as mentioned later. In other words, the control unit 49 and the AGC amplifier 46 correspond to the error detector 1 of the first exemplary embodiment.

The coupler 41 splits the reception signal 401 inputted from the antenna 10 via the DUP 20 into two, a reception signal 402 and a reception signal 408. The reception signal 402 having most of the electric power of the reception signal is outputted to the LNA 42 and the reception signal 408 having a part of the electric power is outputted to the detector 48.

The LNA 42 amplifies the reception signal 402 and outputs an amplified reception signal 403 to the first filter 43. The first filter 43 filters the reception signal 403 and outputs a filtered reception signal 404 to the amplifier 44. The amplifier 44 amplifies the reception signal 404 and outputs an amplified reception signal 405 to the second filter 45. The second filter 45 filters the reception signal 405 and outputs a filtered reception signal 406 to the AGC amplifier 46.

The AGC amplifier 46 amplifies or attenuates the reception signal 406 with the AGC amplifier gain according to a gain control signal 410 from the control unit 49 and outputs the output signal 407 that is AGC controlled to the ADC 47. Here, the gain control signal 410 is a signal for controlling the AGC amplifier gain. The gain control signal 410 is controlled by the control unit 49 so that the signal level of the output signal of the ADC 47, which is the output signal 411 of the receiver 40, converges to a constant value.

The ADC 47 performs an analog-to-digital conversion of the reception signal 407 and outputs the output signal 411 which is converted into a digital form to the demodulator 60 and the control unit 49.

Incidentally, the ADC 47 only converts the output signal 407 which is an analog signal into the output signal 411 which is a digital signal. Accordingly, there is no difference between the signal level of the output signal 407 and the signal level of the output signal 411 although the former is the analog value and the latter is the digital value. Therefore, the function of the AGC with the output signal 411 that is the output signal of the ADC 47 in this exemplary embodiment is essentially the same as that of the AGC with the output signal 407 that is the output signal of the AGC amplifier 46.

The detector 48 detects the reception signal 408 and outputs a detection voltage 409 detected by the detector 48 to the control unit 49. Here, it is assumed that the detector 48 has a sufficiently wide dynamic range.

The detection voltage 409 represents the signal level of the reception signal 408. The reception signal 408 is a signal separated from the reception signal 401 that is the signal inputted to the receiver 40 by the coupler 41. Accordingly, the signal level of the reception signal 401, which is the input signal level, can be known according to the detection voltage 409.

The control unit 49 has a computer function to perform a process based on a predetermined program. The control unit 49 controls the AGC amplifier gain so that the signal level of the output signal 411 outputted from the ADC 47 converges to a constant value. Here, “signal level” means amplitude of an envelope. The control unit 49 outputs the gain control signal 410 to the AGC amplifier 46 in order to perform AGC of the AGC amplifier at an arbitrary settable cycle (hereinafter, referred to as “AGC control cycle”).

Further, the AGC amplifier gain is controlled to the constant value within the AGC control cycle. Accordingly, as long as the receiver 40 is normal, it is expected that the overall gain of the receiver 40 will be kept at the constant value.

The control unit 49 monitors the output signal 411 that has been sampled at a sufficiently shorter time interval than the AGC control cycle. The control unit 49 judges whether or not a variation of the signal level of the output signal 411 within the AGC control cycle is smaller than a threshold value that is arbitrarily set (hereinafter, referred to as “second threshold value”). The “variation” is an absolute value of a difference between a maximum value and a minimum value of the signal level of the output signal 411. Hereinafter, the variation of the output signal 411 within the AGC control cycle is referred to as “output variation”.

When the output variation is smaller than the second threshold value, the control unit 49 calculates the signal level of the reception signal 401 from the antenna 10 and the overall gain of the receiver 40 according to the AGC amplifier gain and the detection voltage 409 from the detector 48. The “overall gain” is a ratio of the signal level of the output signal 411 to the signal level of the input signal 401 and a gain of the whole receiver 40. Specifically, the overall gain is a gain on a whole path after the reception signal 401 is inputted to the coupler 41 until the output signal 411 is outputted from the AGC amplifier 46. The control unit 49 compares the calculated overall gain of the receiver 40 with the first threshold value corresponding to the calculated signal level of the reception signal 401 and judges whether or not the error occurs in the receiver 40. As mentioned above, the second threshold value is the threshold value used for calculating the overall gain and judging whether or not a process should be forwarded to a process for detecting the error of the receiver 40.

The modulator 50 modulates a demodulated signal 501 from the demodulator 60 or a transmission signal 502 from the network (not shown) and outputs the modulated transmission signal 503 to the transmitter 30.

The demodulator 60 receives the output signal 411 (uplink communication signal) and the gain control signal 410 from the receiver 40. The demodulator 60 performs demodulation of the output signal 411, calculation of a signal to interference ratio (SIR) and the like, and outputs the demodulated signal 501 to the modulator 50 or the network (not shown).

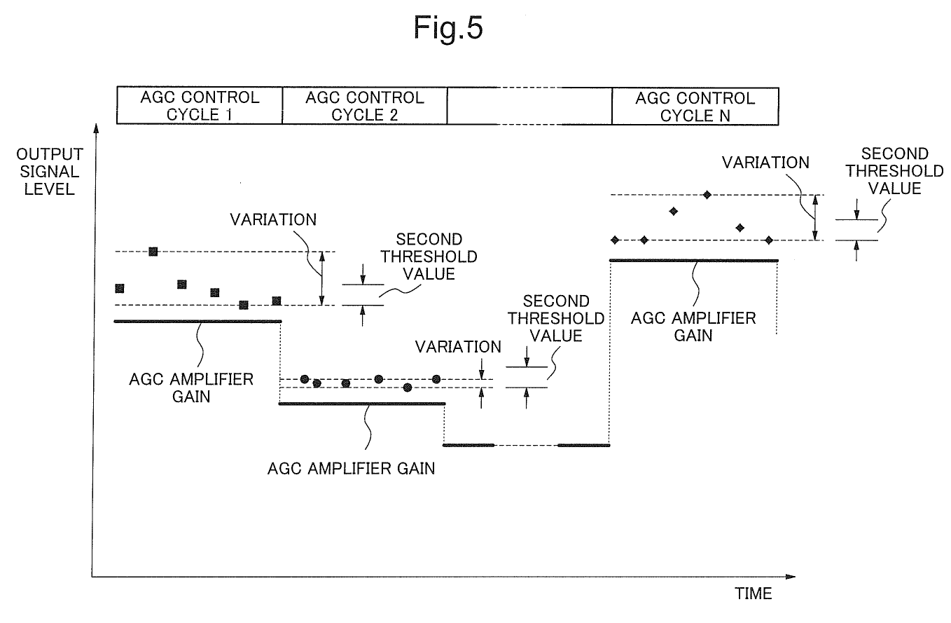

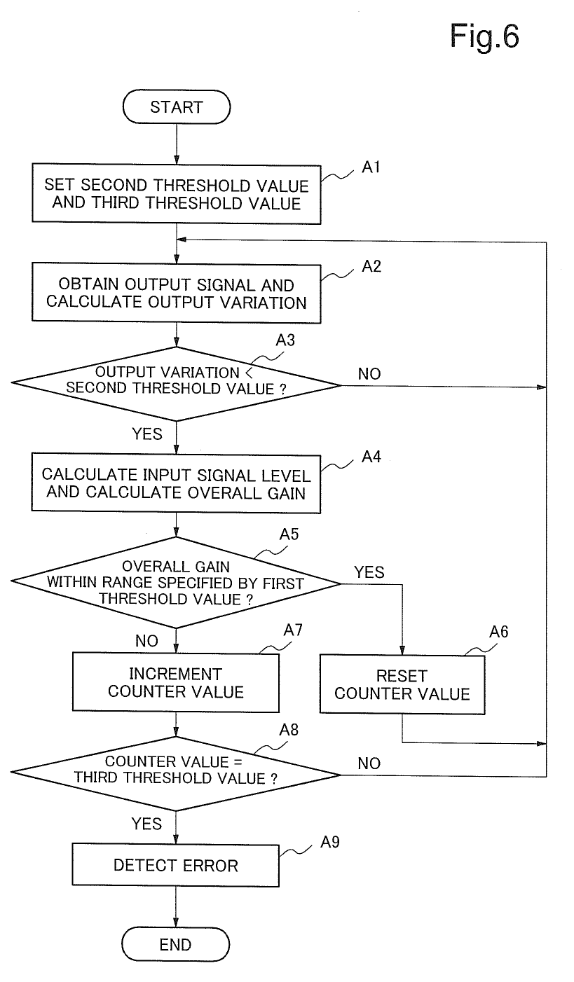

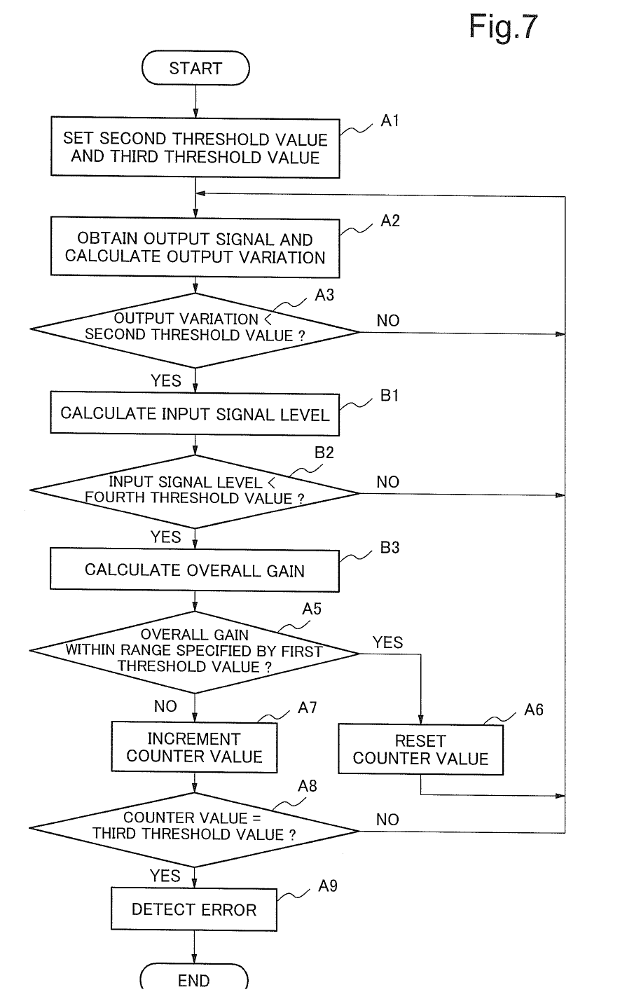

Next, the operation of the wireless base station of the third exemplary embodiment will be described by using a drawing. FIG. 5 shows an example of a time chart of the gain control of the AGC amplifier in the wireless base station of the exemplary embodiment. FIG. 6 shows an example of a flowchart of an error detection operation of the control unit 49 in the wireless base station of the exemplary embodiment. FIG. 7 shows another example of a flowchart of the error detection operation of the control unit in the wireless base station of the exemplary embodiment. Further, all components of the wireless base station are shown in FIG. 4.

As shown in FIG. 5, the gain control of the AGC amplifier 46 is an operation in which the control unit 49 adjusts the AGC amplifier gain for each of the AGC control cycles 1 to N (N is a positive integer) mentioned above according to the gain control signal 410. Because the control is performed so as to keep the AGC amplifier gain constant within the AGC control cycle, as long as each component in the receiver 40 is normal, the overall gain of the receiver 40 can be determined to an unambiguous value (for example, 80 dB). Further, the components in the receiver 40 are the coupler 41, the LNA 42, the first filter 43, the amplifier 44, the second filter 45 and the AGC amplifier 46. When the signal level of the reception signal 401 from the antenna 10 varies during a period in which the control is performed so as to keep the AGC amplifier gain constant, the output signal 411 of the ADC 47 also varies according to the variation of the reception signal 401.

The error detection operation of the control unit 49 will be described with reference to FIG. 5 and FIG. 6. First, the second threshold value and the third threshold value are set to the control unit 49 by an operation from outside (Step A1). For example, these values are set from a terminal connected with the control unit 49 to perform communication. These values can be arbitrarily set. Further, the first threshold value is set in advance in the third exemplary embodiment. The first threshold value may also be set from outside.

As mentioned above, the second threshold value is the threshold value used for judging whether or not to perform the error detection operation of the receiver 40. The second threshold value is compared with the output variation in the operation in step A3 mentioned later. For example, the second threshold value is set to 0.2 dB or the like. In this case, a judgment of whether or not the difference between the maximum value and the minimum value of the signal level of the output signal 411 is within 0.2 dB is performed.

The third threshold value is a threshold value used for judging whether or not the overall gain of the receiver 40 reaches a level at which it is judged that the error occurs in the receiver 40. The control unit 49 compares the number of times (counter value) that it is judged that the overall gain of the receiver 40 is included in the range specified by the first threshold value, with the third threshold value and judges whether or not the error occurs in the receiver 40. The third threshold value is used in the operation in step A8 mentioned later.

After performing the process in step A1, the control unit 49 obtains the output signal 411 which is the ADC output and has been sampled at a shorter time interval than the AGC control cycle. The control unit 49 calculates the output variation within the AGC control cycle (Step A2). As mentioned above, the output variation is the difference between the maximum value and the minimum value of the signal level of the output signal 411 within the AGC control cycle.

After performing the process in step A2, the control unit 49 judges whether or not the calculated output variation (refer to FIG. 5) is smaller than the set second threshold value (Step A3). When the output variation is equal to or greater than the second threshold value (“No” judgment in step A3), the process returns to step A2.

When the output variation is smaller than the second threshold value (“Yes” judgment in step A3), namely, when it is judged that the variation of the signal level of the reception signal 401 inputted from the antenna 10 is smaller than the threshold value, the control unit 49 detects the error of the receiver 40. The control unit 49 obtains the signal level (input signal level) of the reception signal 401 and the overall gain of the receiver 40 according to the AGC amplifier gain and the detection voltage 409 from the detector 48. (Step A4). Specifically, the control unit 49 obtains the input signal level of the reception signal 401 according to the detection voltage 409. The control unit 49 calculates the overall gain of the receiver 40 according to the signal level of the reception signal 401 and the AGC amplifier gain.

Thus, only when the output variation is smaller than the second threshold value, the signal level and the overall gain are calculated in order to detect the error and the error detection process is performed. Therefore, the error can be detected without being affected by a fading or a burst reception of a control channel.

After performing the process in step A4, the control unit 49 judges whether or not the calculated overall gain of the receiver is included in the range specified by the first threshold value (step A5). Namely, the control unit 49 judges whether or not the overall gain is included in the range in which the overall gain is judged as normal. At that time, the first threshold value is not a fixed value and it is set according to the calculated signal level. Accordingly, the range specified by the first threshold value varies according to the signal level. Further, in order to improve reliability of the error detection, it is desirable that when a state in which the overall gain is not included in the range specified by the first threshold value occurs continuously many times, it is judged that the error occurs in the receiver 40 and it is treated as the formal judgment of the error detection.

Further, the control unit 49 absorbs a difference between a delay time after the reception signal 401 changes until the output signal 411 changes and a delay time after the reception signal 401 changes until the detection voltage 409 changes. For example, the control unit 49 may calculate this delay time difference in advance and perform the above mentioned judgment by using the output signal 411 and the detection voltage 409 at the time which is shifted by the delay time difference. Additionally, the error can be more precisely detected by changing the first threshold value with a frequency of the reception signal 401 or a temperature of the receiver 40.

When it is judged that the overall gain of the receiver is included in the range specified by the first threshold value (“Yes” judgment in step A5), the control unit 49 resets the counter value to “0” (Step A6) and the process returns to step A2.

Incidentally, because linearity of the gain of all components of which the receiver 40 is composed depends on the signal level of the reception signal 401 from the antenna 10, the linearity of the gain is degraded and the gain may be decreased when the signal level of the reception signal 401 increases. Therefore, even when the overall gain of the receiver is decreased, the control unit 49 does not judge that the error occurs in the receiver 40 immediately. When the control unit 49 judges that the AGC amplifier gain can be compensated, the control unit 49 judges that the receiver 40 operates normally.

For example, when it is assumed that the reception signal 401 with the signal level of −80 dBm is inputted, the gain of the LNA 42 is changed from 18 dB to 17 dB, and the AGC amplifier gain is changed from 40 dB to 41 dB, the control unit 49 judges that the receiver 40 operates normally if the calculated overall gain of the receiver 40 is included in the range specified by the first threshold value. In this way, normality of the receiver 40 can be judged by using the signal level of the reception signal 401 inputted from the antenna 10 and the AGC amplifier gain.

When it is judged that the overall gain of the receiver is not included in the range specified by the first threshold value (“No” judgment in step A5), the control unit 49 increments the counter value by one (Step A7).

After performing the process in step A7, the control unit 49 judges whether or not the counter value reaches the third threshold value set in advance (Step A8). When the counter value does not reach the third threshold value (“No” judgment in step A8), the process returns to step A2.

When the counter value reaches the third threshold value (“Yes” judgment in step A8), the control unit 49 judges that the error occurs in the receiver 40 and outputs an error detection signal 412 (Step A9), and ends the process. A device which receives the error detection signal 412 and is informed of occurrence of the error performs a predetermined process to respond to the occurrence of the error.

Further, the input signal level which saturates each of the components in the receiver 40 (the input signal level which degrades the linearity of each of the components in the receiver 40) may be set to the control unit 49 as a fourth threshold value. In this case, when the reception signal with the signal level equal to or greater than the fourth threshold value is inputted, an error detection flow may be stopped so as not to advance to a process to calculate the overall gain. FIG. 7 shows a modification example of the error detection operation of the control unit shown in FIG. 6.

As shown in FIG. 7, when the output variation is smaller than the second threshold value (“Yes” judgment in step A3) after the processes are performed that are similar to the processes from step A1 to step A3 shown in FIG. 6, it is judged whether or not the input signal level is the signal level which saturates each of the components in the receiver 40. First, the control unit 49 calculates the signal level of the reception signal from the antenna 10 according to the AGC amplifier gain and the detection voltage from the detector 48 (Step B1).

After performing the process in step B1, the control unit 49 judges whether or not the calculated input signal level is smaller than the fourth threshold value set in advance (Step B2). When the input signal level is not smaller than the fourth threshold value (“No” judgment in step B2), the process returns to step A2.

When the input signal level is smaller than the fourth threshold value (“Yes” judgment in step B2), the control unit 49 calculates the overall gain of the receiver 40 according to the AGC amplifier gain and the detection voltage 409 from the detector 48 (Step B3).

After the process in step B3 is performed, a judgment of whether or not the error occurs in the receiver 40 is performed by the processes that are similar to the processes from step A5 to step A9 shown in FIG. 6.

As mentioned above, the wireless base station of the third exemplary embodiment uses a simple method in which the wireless base station does not use a known test signal and uses the reception signal 401 inputted from the antenna 10 as the test signal. The wireless base station measures the overall gain of the receiver 40 in a period (AGC control cycle) in which the AGC amplifier gain is kept at the constant value, and compares the calculated overall gain with the overall gain that is judged as normal (first threshold value). Therefore, the error can be detected correctly without being affected by a fading or a burst reception of a control channel.

The wireless base station of the third exemplary embodiment has the following advantages.

First, the wireless base station of the exemplary embodiment does not use the known test signal but uses the reception signal inputted from the antenna as a signal source for the error detection when detecting the error of the receiver. Therefore, it is not necessary to stop the operation of the receiver. Accordingly, the wireless base station has an advantage in which the error of the receiver can be detected without stopping the system operation even if the wireless base station is provided with only one receiver.

Secondly, the wireless base station of the exemplary embodiment does not detect the error of the receiver while stopping operation service of one receiver among a plurality of receivers. The wireless base station detects the error of the receiver by using the reception signal inputted from the antenna as a signal source for the error detection. Accordingly, the present exemplary embodiment has an advantage that the error detection can be performed without reducing a service area of the wireless base station having the plurality of receivers, degrading quality of communication or disconnecting a call of a user near the boundary of the service area.

Thirdly, the wireless base station of the exemplary embodiment does not use only the thermal noise as the test signal for the error detection. The wireless base station detects the error of the receiver 40 when the variation of the signal level of the reception signal inputted from the antenna is within a predetermined range. Therefore, the present exemplary embodiment has an advantage that the error detection can be performed according to the input signal level.

Fourth, the wireless base station of the exemplary embodiment does not need many selection switches, a signal to control these switches, a termination circuit and the like in order to detect the error of the receiver. Therefore, the present exemplary embodiment has an advantage addition of a circuit for error detection and degradation of the reception performance can be minimized.

### 4. Fourth Exemplary Embodiment

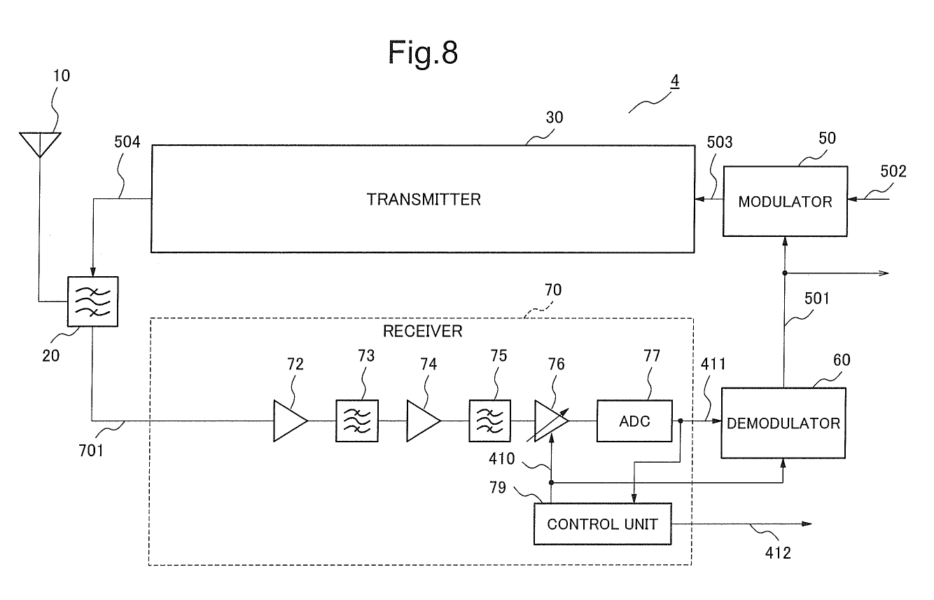

A wireless base station of the fourth exemplary embodiment of the present invention will be described by using a drawing. FIG. 8 is a block diagram showing a configuration of the wireless base station of the fourth exemplary embodiment of the present invention.

A receiver 70 of a wireless base station 4 of the fourth exemplary embodiment does not use the coupler 41 and the detector 48 that are used in the receiver 40 of the third exemplary embodiment shown in FIG. 1. An LNA 72, a first filter 73, an amplifier 74, a second filter 75, an AGC amplifier 76, an ADC 77 and a control unit 79 correspond to the LNA 42, the first filter 43, the amplifier 44, the second filter 45, the AGC amplifier 46, the ADC 47 and the control unit 49 in the receiver 40, respectively.

In the fourth exemplary embodiment, the control unit 79 maintains long term statistics of the AGC amplifier gain set to the AGC amplifier 76, obtains a statistical data and compares the statistical data with a threshold value that can be arbitrarily set (hereinafter, referred to as “fifth threshold value”). Because the error is detected according to the statistical data, the reception signal coupler 41 and the detector 48 can be omitted. The fifth threshold value is set to for example, 10 dB.

In the statistical processing, for example, a time average value of the AGC amplifier gain is obtained and it is judged that an error occurs when the absolute value of the difference between the latest AGC amplifier gain and the average value is greater than the fifth threshold value. It may be judged that the error occurs when a ratio of the latest AGC amplifier gain to the average value is not included in the range specified by the fifth threshold value. As mentioned above, various error detecting methods using the statistics of the AGC amplifier gain can be utilized.

The wireless base station of the fourth exemplary embodiment detects occurrence of the error of the receiver by using the statistical processing. Accordingly, the wireless base station can detect the error of the receiver without stopping the operation of the system and inputting the known test signal.

### 5. Fifth through Eighth Exemplary Embodiments

The related art described in Background Art and disclosed in Japanese Patent Application Laid-Open No. 2002-246978 causes a problem such as increase in size of the device or increase in power consumption because the test signal is used.

In the method described in Japanese Patent Application Laid-Open No. 2006-319616, the test signal is not used. However, it has the following problems. First, the wireless base station having only one receiver cannot detect the error while operating the system. That is because when the error detection is performed, a connection of the receiver has to be changed, from the connection between the input terminal of the receiver and the antenna to the connection between the input terminal of the receiver and a termination circuit, for inputting the thermal noise as the signal source for the error detection.

Secondly, even if the wireless base station includes the plurality of receivers, there is a possibility in which a service area for an uplink communication line is reduced and quality of communication is degraded or a call is disconnected for a user near the boundary of the service area. That is because the connection of the receiver, which is a target for the error detection, is changed from the connection between the input terminal of the receiver and the antenna to the connection between the input terminal of the receiver and a termination circuit for inputting the thermal noise as the signal source for the error detection, and a reception diversity effect is reduced.

Third, the error of the receiver that depends on the signal level of the input signal cannot be detected. That is because only the thermal noise is used as the test signal for the error detection.

Fourth, the reception performance is degraded. That is because many circuits and signals used for only the error detection such as selection switches and switch control signals used for detecting the error of the receiver are used in the receiver.

A fifth exemplary embodiment of the present invention is a wireless base station including the receiver which receives the signal from the mobile terminal via the antenna, and is characterized in that the receiver includes: the AGC amplifier which amplifies or attenuates the reception signal from the antenna and outputs the reception signal; and a control unit which controls the gain of the AGC amplifier so as to keep the output of the receiver constant, and the control unit calculates the overall gain of the receiver according to the AGC amplifier gain, compares the calculated overall gain with the overall gain that is a threshold value for judging whether or not the wireless base station operates normally, and detects the error of the receiver.

A sixth exemplary embodiment of the present invention is a receiver which receives a signal from the mobile terminal via the antenna, and is characterized in that the receiver includes: the AGC amplifier which amplifies or attenuates the reception signal from the antenna and outputs the reception signal; and the control unit which controls the gain of the AGC amplifier so as to keep the output of the receiver constant, and the control unit calculates the overall gain of the receiver according to the AGC amplifier gain, compares the calculated overall gain with the overall gain that is a threshold value for judging whether or not the receiver operates normally, and detects the error of the receiver.

A seventh exemplary embodiment of the present invention is an error detecting method of the receiver which receives the signal from the mobile terminal via the antenna, and is characterized in that the method includes: a step for controlling the gain of the AGC amplifier so as to keep the output of the receiver constant; a step for calculating the overall gain of the receiver according to the AGC amplifier gain; and a step for comparing the calculated overall gain with the overall gain that is the threshold value for judging whether or not the receiver operates normally and detecting the error of the receiver.

An eighth exemplary embodiment of the present invention is an error detection program of the receiver, and is characterized in that the program causes the receiver to perform each step of the error detecting method of the receiver.

In the fifth through eighth exemplary embodiments, a simple method is used in which the known test signal is not inputted and the reception signal inputted to the receiver is used. The signal level of the input signal from the antenna and the overall gain are measured within a period in which the gain of the AGC amplifier is kept constant. The measured signal level and overall gain are compared with the overall gain that is the threshold value for judging whether or not the receiver operates normally. Therefore, the error can be detected without being affected by a fading or a burst reception of a control channel. Accordingly, the error of the receiver can be detected correctly without affecting the system operation and with minimal degradation of the reception performance.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. An error detector, comprising:
an automatic gain control amplifier for amplifying or attenuating an input signal with a variable gain and outputting an output signal; and
a control unit for controlling the variable gain so as to keep a signal level of the output signal constant, obtaining an overall gain according to the variable gain and the signal level of the input signal, and detecting an error according to a result of a comparison of the overall gain with a first threshold value.

2. The error detector according to claim 1, wherein the control unit detects the error according to a judgment of whether or not the overall gain is within a range specified by the first threshold value.

3. The error detector according to claim 1, wherein the control unit detects the error according to a result of a comparison of a variation of the signal level of the output signal with a second threshold value.

4. The error detector according to claim 3, wherein the control unit detects the error when the variation of the signal level of the output signal is smaller than the second threshold value.

5. The error detector according to claim 1, wherein the control unit samples the output signal at a predetermined time interval and controls the variable gain at a predetermined cycle which is longer than the time interval.

6. The error detector according to claim 5, wherein the control unit obtains the plurality of overall gains by sampling the output signal multiple times within the cycle, compares each of the plurality of overall gains with the first threshold value, and judges whether the error occurs according to the plurality of results of the comparisons and a third threshold value.

7. The error detector according to claim 1, wherein the control unit detects the error when the signal level of the input signal is smaller than a fourth threshold value.

8. The error detector according to claim 7, wherein the fourth threshold value is the signal level of the input signal at which a device in the receiver is driven into saturation.

9. The error detector according to claim 1, wherein the control unit obtains the plurality of overall gains by sampling the output signal multiple times and detects the error according to a result of a comparison between one of the plurality of overall gains and a fifth threshold value obtained from a result of statistics of the plurality of overall gains.

10. The error detector according to claim 1, wherein
the variable gain has a predetermined settable range, and
the control unit judges that the error occurs when the signal level of the output signal cannot be controlled so as to hold constant with a gain within the settable range.

11. The error detector according to claim 1, wherein the first threshold value is set according to the signal level of the input signal.

12. The error detector according to claim 1, wherein the first threshold value is set according to the signal level of the input signal.

13. The error detector according to claim 1, wherein the error is an error of a signal source of the input signal or the automatic gain control amplifier.

14. The error detector according to claim 1, wherein the control unit comprises:
a level measuring unit for measuring the signal level of the input signal;
a gain setting unit for setting the variable gain; and
an error detecting unit for obtaining the overall gain according to the variable gain and the signal level of the input signal, and judging whether or not the error occurs.

15. An error detector, comprising:
variable gain amplifying means for amplifying or attenuating an input signal with a variable gain and outputting an output signal; and
controlling means for controlling the variable gain so as to keep a signal level of the output signal constant, obtaining an overall gain according to the variable gain and a signal level of the input signal, and detecting an error according to a result of a comparison of the overall gain with a first threshold value.

16. A receiver comprising the error detector according to claim 1.

17. The receiver according to claim 16, further comprising:
a coupler for separating the input signal from a reception signal; and
a detector for detecting the input signal and obtaining the signal level of the input signal.

18. A wireless base station comprising the error detector according to claim 1.

19. The wireless base station according to claim 18, further comprising:
an antenna for receiving a wireless signal and outputting a reception signal;
a coupler for separating the input signal from the reception signal; and a detector for detecting the input signal and obtaining the signal level of the input signal.

20. An error detecting method comprising the steps of:
controlling a variable gain set to an automatic gain control amplifier which amplifies or attenuates an input signal with the variable gain and outputs an output signal, so as to keep a signal level of the output signal constant;
obtaining an overall gain according to the variable gain and a signal level of the input signal; and
detecting an error according to a result of a comparison of the overall gain with a first threshold value.

21. A control program for an error detector for controlling the steps of:
controlling a variable gain set to an automatic gain control amplifier provided in the error detector which amplifies or attenuates an input signal with the variable gain and outputs an output signal so as to keep a signal level of the output signal constant;
obtaining an overall gain according to the variable gain and a signal level of the input signal; and
detecting an error according to a result of a comparison of the overall gain with a first threshold value.

22. A medium storing the program according to claim 20.
